(19) United States
(12) Patent Application Publication
(10) Pub. No.: US 2010/0325154 A1
(43) Pub. Date: Dec. 23, 2010

(54) METHOD AND APPARATUS FOR A VIRTUAL IMAGE WORLD

(75) Inventors: C. Philipp Schloter, San Francisco, CA (US); Matthias Jacob, London (GB)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/489,388

(22) Filed: Jun. 22, 2009

(51) Int. Cl. G06F 17/30

(52) U.S. Cl. 707/770; 707/705; 707/802

(57) ABSTRACT

An approach is provided for the filtering user-generated image recognition content. An object data and associated location information are received. The object data represents an image of a physical object within a physical environment. Storage is initiated of the received object data and location information. The received object data is associated with a virtual environment corresponding to the physical environment. Approval is initiated of the received object data for inclusion in a filtered virtual environment.

### BACKGROUND

Service providers and device manufacturers (like wireless (e.g., cellular) are continually challenged to deliver value and convenience to consumers by, for example, providing compelling network services. These network services can include services for relaying information about an object to a mobile device. However, it is difficult to add content to these network services to provide more information about the object.

### SOME EXAMPLE EMBODIMENTS

According to one embodiment, a method comprises receiving object data and associated location information. The object data represents an image of a physical object within a physical environment. The method also comprises initiating storage of the received object data and the location information. The method further comprises associating the received object data with a virtual environment corresponding to the physical environment. The method additionally comprises initiating approval of the received object data for inclusion in a filtered virtual environment.

According to another embodiment, an apparatus comprising at least one processor, and at least one memory including computer program code, the at least one memory and the computer program code configured to, with the at least one processor, cause the apparatus to receive object data and associated location information. The object data represents an image of a physical object within a physical environment. The apparatus is also caused to initiate storage of the received object data and the location information. The apparatus is further caused to associating the received object data with a virtual environment corresponding to the physical environment. The apparatus is additionally caused to initiate approval of the received object data for inclusion in a filtered virtual environment.

According to another embodiment, a computer-readable storage medium carrying one or more sequences of one or more instructions which, when executed by one or more processors, cause an apparatus to receive object data and associated location information. The object data represents an image of a physical object within a physical environment. The apparatus is also caused to initiate storage of the received object data and the location information. The apparatus is further caused to associating the received object data with a virtual environment corresponding to the physical environment. The apparatus is additionally caused to initiate approval of the received object data for inclusion in a filtered virtual environment.

According to another embodiment, an apparatus comprises means for receiving object data and associated location information. The object data represents an image of a physical object within a physical environment. The apparatus also comprises means for initiating storage of the received object data and the location information. The apparatus further comprises means for associating the received object data with a virtual environment corresponding to the physical environment. The apparatus additionally comprises means for initiating approval of the received object data for inclusion in a filtered virtual environment.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of filtering media recognition content for a virtual environment (or world), according to one embodiment;

FIG. 2 is a diagram of the components of a user equipment, according to one embodiment;

FIG. 3 is a flowchart of a process for filtering image recognition content for a virtual world, according to one embodiment;

FIGS. 4A-4B are diagrams of user interfaces utilized in the processes of FIG. 3, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile station (e.g., handset) that can be used to implement an embodiment of the invention.

### DESCRIPTION OF SOME EMBODIMENTS

A method and apparatus for filtering image recognition content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

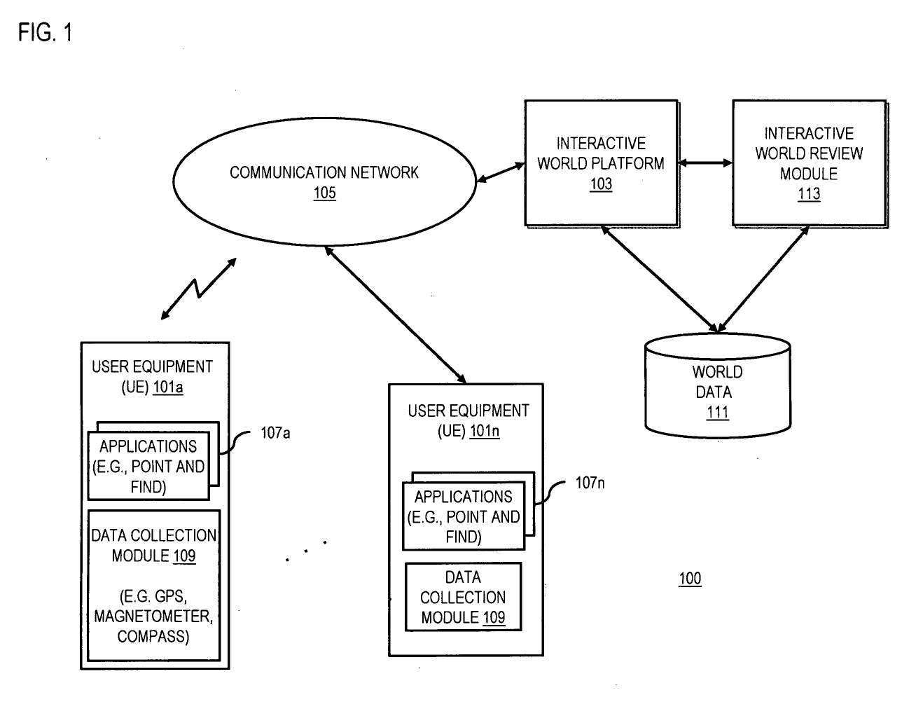

FIG. 1 is a diagram of a system capable of filtering image recognition content, according to one embodiment. In a mobile environment (or world), increasing services and applications utilize media capture devices to capture media (e.g., photos or video clips). These services and applications can also include applications to recognize the contents of an image stream or captured media to retrieve information about objects contained in the image stream or in the media. In one embodiment, a virtual world can be used to interact with users in the real world. According to certain embodiments, objects can be identified by the location of the objects as well as information and/or metadata of the objects. The information and metadata can include tags or labels associated with the objects. However, traditionally, it is difficult for a service to allow an individual to add information and/or metadata about objects or create new objects.

To address this problem, a system 100 of FIG. 1 introduces the capability to filter and edit image recognition content in an interactive virtual environment (or world). A user equipment (UE) 101 can be used by a user to capture media content (e.g., photographs) and send the media to an interactive world platform 103 via a communication network 105. The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), positioning device, camera/camcorder device, audio/video player, television, or any combination thereof. It is also contemplated that the UE 101 can support any type of interface to the user (such as “wearable” circuitry, etc.). In one embodiment, the UE 101 may use an application 107, such as a point and find application 107a-107n, to receive information about an object contained in media content captured via a data collection module 109. The data collection module 109 can capture media content (e.g., images, sound, etc.) as well as location information (e.g., global positioning system (GPS), magnetometer, and compass information). Additionally, the UE 101 may use an application 107 to send information about an object or to create an object using captured media content.

In one embodiment, an interactive world platform 103 can receive captured media (e.g., an image) to add objects associated with the media to a public virtual world. This public virtual world can be accessed by other people or users associated with the services of the interactive world platform 103. Multiple such public virtual worlds can be supported by the interactive world platform 103. In one embodiment, when an interactive world platform 103 receives a request to update a virtual world with an object and a tag and/or label, the interactive world platform 103 stores the object and tag and/or label in a world data database 111 in a second private virtual world where the object and tag and/or label can be reviewed for filtering by an interactive world review module 113. In one embodiment, the tag and label can include any information, such as text string, icon, image, applet, widget, Internet blog, Internet link, or any combination. The information may be user created content, or it may originate fully or partly from a third party, such as from an advertisement service provider, as an Really Simple Syndication (RSS) feed from Internet, from the interactive world platform 103, from the world data database 111, and/or from the interactive world review module 113. The interactive world platform 103, world data database 111 and interactive world review module 113 can be or locate in same entity or device, or be separate entities or devices. In essence, the review module 113 processes objects and tags and/or labels for approval based on predetermined criteria, for example filters. Once the interactive world review module 113 has reviewed the object and tag and/or label, allowable content can be placed in the requested virtual world and stored in the world data database 111. Additionally, the interactive world review module 113 can approve the objects and tags and/or labels for one or more virtual world and reject them for other one or more virtual world, for example based on the predetermined criteria.

In some embodiments, the world data database 111 can comprise multiple databases, using a centralized or distributed architecture. In one embodiment, if the interactive world review module 113 determines that the content is unallowable (or otherwise not permitted); the interactive world review module 113 can reject the request and notify the requestor of the reasons why the content is unallowable. The requester can then send a modified request. In other embodiments, the interactive world review module 113 can reject the request and delete the content.

In one embodiment, the system 100 has an interactive world review module 113. In one embodiment, the interactive world review module 113 reviews content that a user requests to upload to a virtual world for other users to see. In one embodiment, the interactive world review module 113 is an editor module. The uploaded content is redirected from being uploaded in the virtual world to a private virtual world that is accessed by the interactive world review module 113. In one embodiment, the interactive world review module 113 is overseen by an editor. In this embodiment, the editor reviews the content in the private virtual world, such as an editor world, and moves approved content to the virtual world that the user requested to upload to. As used herein, the term public virtual world refers to accessibility of the virtual environment by the general public, whereas private virtual world involves access by only certain designated users, such as editors.

In one embodiment, the review process is fully automated. In this embodiment, a computer, e.g., an editor, reviews the content using recognition techniques, e.g., image recognition, location recognition, character string recognition, metadata analysis, tag analysis, label analysis, etc., to filter out content that is illegal, obscene, undesired, lacks quality, lacks technical requirements, and/or other evaluation criterion. In one embodiment, an image that lacks a specific quality (e.g., is too large) can be edited/modified (e.g., cropped, resized, resolution reduced, etc.) instead of filtered out. The pictures or other media submitted, the location of the picture, the label or tag submitted, the metadata, and/or other data about the object can be used to filter the content. In one embodiment, a tag and/or label can focus on a portion of an image. In some embodiments, the review process is partially automated, where a computer reviews and flags content based on filters and an overseer (or reviewer or the editor) reviews the flagged content for final approval or rejection. When an upload request is rejected, reason for the disapproval can be stated so the user can correct the problem.

As shown in FIG. 1, the UE 101 has connectivity to an interactive world platform 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

By way of example, the UE 101 and interactive world platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

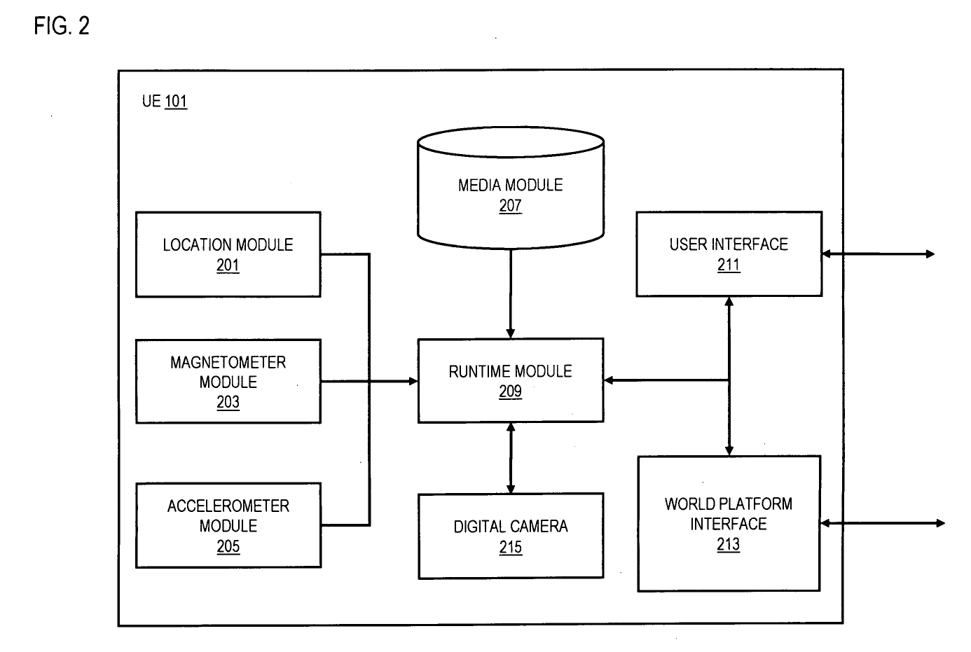

FIG. 2 is a diagram of the components of a user equipment 101, according to one embodiment. By way of example, the user equipment includes one or more components for filtering image recognition content in a virtual world. It is contemplated that the functions of these components may be combined in one or more components or performed by other components of equivalent functionality. In this embodiment, the UE 101 includes 107 includes one or more location modules 201, magnetometer modules 203, accelerometer modules 205, media modules 207, runtime modules 209, user interfaces 211, world platform interfaces 213, digital cameras 215, and/or memory modules (not shown).

In one embodiment, a UE 101 includes a location module 201. This location module 201 can determine a user's location. The user's location can be determined by a triangulation system such as GPS, A-GPS, Cell of Origin, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. GPS coordinates can give finer detail as to the location of the UE 101 when media is captured. In one embodiment, GPS coordinates are embedded into the metadata of captured media to facilitate filtering and placement of image recognition content in a virtual world.

In one embodiment, a UE 101 includes a magnetometer module 203. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer is embedded into the metadata of captured or streaming media to facilitate image recognition and filtering.

In one embodiment, a UE 101 includes an accelerometer module 205. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module can determine the angle the UE 101 is pointed as compared to Earth's gravity. In one embodiment, vertical directional data obtained from an accelerometer is embedded into the metadata of captured or streaming media to help facilitate image recognition and filtering.

In some embodiments, a UE 101 includes a media module 207. Media can be captured using a digital camera 215, an audio recorder, or other media capture device. In one embodiment, media is captured in the form of an image or video. In one embodiment, the digital camera can be a camcorder. The media module 207 can obtain the image from a digital camera 215 and embed the image with metadata containing location and orientation data. The media module 207 can also capture images using a zoom function. If the zoom function is used, media module 207 can embed the image with metadata regarding zoom lens settings. A runtime module 209 can process the image or a stream of images to send content to an interactive world platform 103 via a world platform interface 213.

In one embodiment, a UE 101 includes a world platform interface 213. The world platform interface 213 is used by the runtime module 209 to communicate with an interactive world platform 103. In some embodiments, the world platform interface 213 is used to upload media to make objects visible, e.g., present the objects, to other users after filtering via the interactive world platform 103.

In one embodiment, a UE 101 includes a user interface 211. The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, etc. A user can input a request to upload or receive object information via the user interface 211.

In one embodiment, a UE 101 includes a runtime module 209. In one embodiment, the runtime module 209 runs a point and find application 107 and receives an input from a user interface 211 to provide receive object information. A user points a digital camera 215 associated with the UE 101 at an object. The runtime module 209 can retrieve a digital image of the digital camera 215 (e.g., a snapshot of streaming images in the viewfinder) and send the image to an interactive world platform 103 via a world platform interface 213 with a request for information about objects in the image. The image can have metadata including the location of the UE 101 and the orientation of the digital camera 215. The request can additionally include context information that describes the context of the UE 101 based on one or more of the modules of 201, 203, 205, 207 and 215. In one embodiment, the runtime module 209 can specify a virtual world to retrieve the content from based on the information in the request. The virtual world can be associated with a content provider, e.g., a social networking service, a news service, a travel service, a guide service, such as a tourism landmark service or a restaurant guide, a user support service, advertising services etc., and can be public or private, e.g., based on subscription, and/or social network group specific. Content from the content providers can be filtered to include only information relevant to the content provider.

In one embodiment, the interactive world platform 103 can receive and process the image, location data and/or metadata to determine if the interactive world platform 103 has information about any objects in the image. If there is information, the interactive world platform 103 sends the information to the runtime module 209, which can display the information on a user interface 211 along with the image or viewfinder stream relating to the specific virtual world. In one embodiment, the interactive world platform 103 determines how many objects are available for image recognition in an area (e.g., based on a radius, predetermined proximity and/or named geographical area) surrounding the UE 101. The interactive world platform 103 can determine the number of objects by receiving location information of the UE 101 and comparing that information with objects with location identifiers, for example within a certain distance from the UE 101. The number of objects can be correlated to one of many virtual worlds. In this embodiment, the interactive world platform 103 sends the determined object information to the runtime module 209. The runtime module 209 can then process and display the information on a user interface 211. In one embodiment, the number of recognizable objects nearby for each of a set, or total number of the objects, of virtual worlds is displayed on the user interface 211. In another embodiment, the number of recognizable objects can be represented by an icon that indicates recognizable object density, for example by size of the icon or a bar. This allows a user to be aware of how well image recognition may work in a particular physical environment around the user's location. Based on this information, the user can choose a virtual world. In one embodiment, the runtime module 209 caches object information for objects in a nearby location. In one embodiment, the runtime module 209 determines the UE 101 location using a location module 201. When the UE 101 leaves one area and enters another area, the runtime module 209 can retrieve an updated set of object information from the interactive world platform 103. In one embodiment, the runtime module 209 can display virtual world content on a map or other application. In one embodiment, a map application can access the information stored on the interactive world platform 103. In another embodiment, the map application retrieves its information from a point and find application 107. In another embodiment, the interactive world platform 103 provides user created content to a map provider and the map provider puts that data as part of map data. When updates are sent the users are provided the updated information via the map provider. Location and exploration data in a map application can be used to map the user created content into the correct place. In one embodiment, categorization of the user created data may follow the categorization of a map application or a navigator application related to a map. In some embodiments the map data is time stamped so that it can be controlled and dropped when the data is not anymore useful. In another embodiment, a UE 101 is used to upload information to the interactive world platform 103. In one embodiment, the runtime module 209 can specify a virtual world to upload the content to. For example, the runtime module 209 can capture an image of an object (e.g., a restaurant, a landmark, a park bench, etc.) and embed tag and/or metadata including location and orientation information in the image. The runtime module 209 can also tag the image using a user interface 211. In one embodiment, the tag is specific to a point and find application 107, in another embodiment, the tag can be used in other applications such as a map application or a navigation application. The runtime module 209 can then transmit the tag, image, location, and orientation information to the interactive world platform 103. The interactive world platform 103 can process the information and filter the content via another virtual world and the interactive world review module 113. If the content is allowable, the image is uploaded to the specified virtual world in a location corresponding to the real world (or physical) location of the object. In one embodiment, the content is not allowable. In this exemplary embodiment, the runtime module 209 is notified of the reason (e.g., the image is blurry, the tag content is obscene, the image would degrade recognition, etc.). The user can then correct the problematic reasons provided and resubmit the content.

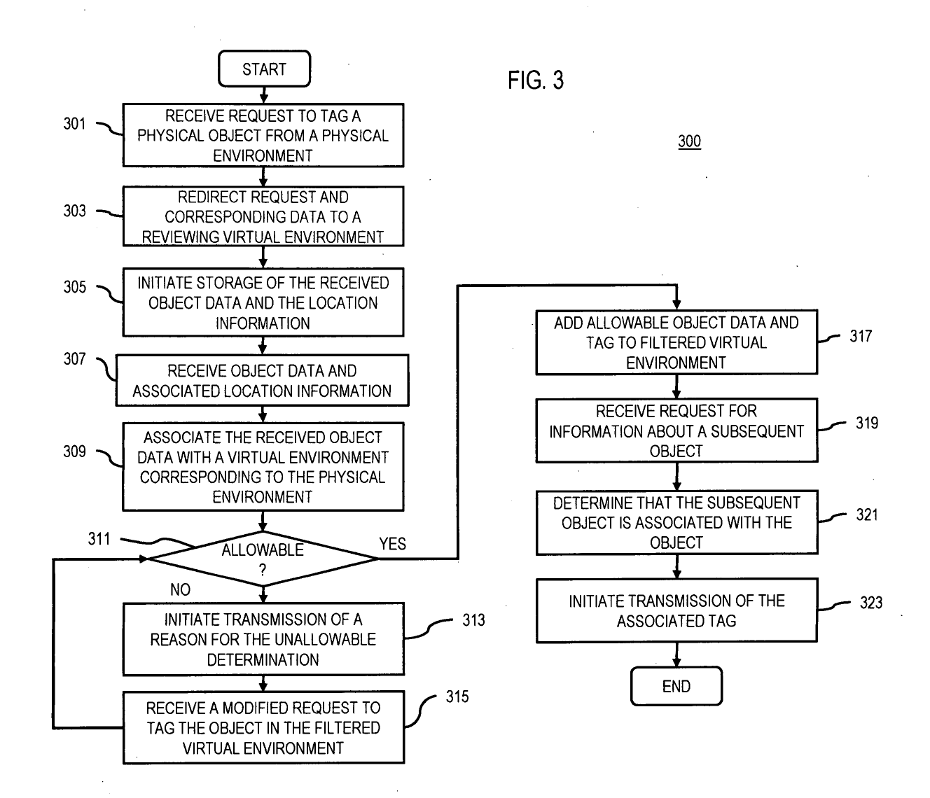

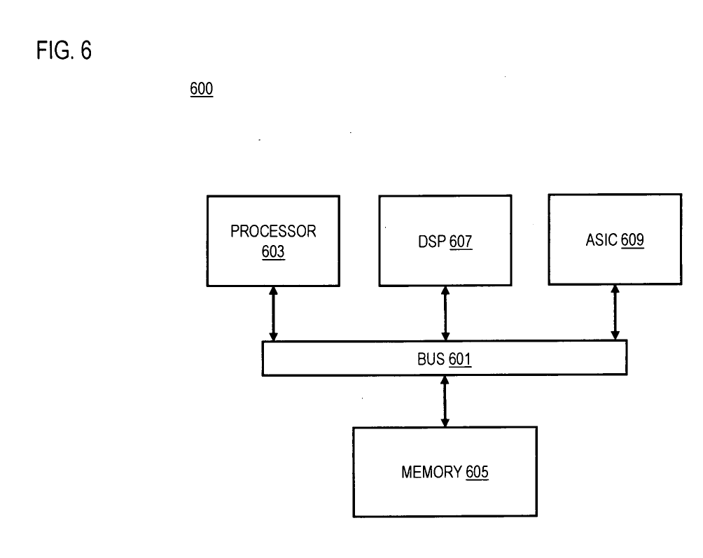

FIG. 3 is a flowchart of a process for filtering image recognition content for a virtual world, according to one embodiment. In one embodiment, the interactive world platform 103 performs the process 300 and is implemented in, for instance, a chip set including a processor and a memory as shown FIG. 6. In step 301, the interactive world platform 103 receives a request to tag a physical object associated with a physical environment. The request can be obtained from a UE 101. The request can also be associated with one of many filtered virtual environments. The filtered virtual environments can also include private and public virtual environments. In one embodiment, the UE 101 can determine which filtered virtual environment is requested. In this embodiment, the UE 101 can determine the filtered virtual environment options, for example based on a user context (e.g., the user can select a restaurant option on the UE 101 if the object is a restaurant, a user can select a tourism option if the object is a landmark). At step 303, the interactive world platform 103 can redirect the request to a reviewing virtual environment.

At step 305, the interactive world platform 103 initiates storage of the received object data, metadata and/or the location information. The received object data, metadata, and/or location information can be stored in a world data database 111. The world data database 111 can include a database for the reviewing virtual environment. The world data database 111 can also include a database for one or more filtered virtual environments.

At step 307, the interactive world review module 113 receives the object data and associated metadata and/or location information. The object data represents an image of a physical object within a physical environment. The object data can also include a tag and/or other label. The UE 101 can append or attach the tag and/or label to the object data. In one embodiment, the reviewing virtual environment is associated with an interactive world review module 113.

At step 309, the interactive world platform 103 associates the received object data with a virtual environment corresponding to the physical environment. This virtual environment can be a virtual environment created to facilitate reviewing, filtering, and editing of object data before the object data is added to a virtual environment that can be accessed by additional users.

At step 311, the interactive world review module 113 initiates approval of the received object data for inclusion in a filtered virtual environment. In one embodiment, the interactive world review module 113 is a part of the interactive world platform 103. In one embodiment, determination of approval of the received object data is based on criteria. The criteria can be determined by the filtered virtual environment. In one embodiment, the filtered virtual environment is an advertising environment, a tourism environment, a dining environment, a guide environment, a combination thereof, or the like. The criteria can be specific to the environment (e.g., no stores in a dining environment) or general (e.g., no obscenity, image quality requirements, location requirements, etc.). In one embodiment, virtual environments based on various criteria can have separate criteria for allowing advertisements. The criteria can include an identifier associated with a user that identifies the user as a paid user, thus allowing the advertisement. In one embodiment, different virtual environments can be sponsored by certain advertisers. In this embodiment, other advertisers are prohibited by the criteria to upload advertising content using the service, for example on a certain area of the virtual environment, or on the entire virtual environment. In another embodiment, an advertisement provider is able to post content before the review process is completed. In this embodiment, the advertisement sponsor's uploaded content is not redirected to the interactive world review module 113. Instead, a copy is made on both the filtered virtual environment and the reviewing virtual environment. The content is made immediately available on the filtered virtual environment, but can be removed if the interactive world review module 113 does not approve the content. In one embodiment, the advertisement providers can have this priority available while other users' content waits for approval before being posted to the filtered virtual environment. In another embodiment, the user who selects the object or creates the object data can select a specific advertisement, type and/or genre of the advertisement, and/or the advertiser who's advertisement that is displayed with the object. In yet another embodiment, the advertiser can select the specific advertisement, type and/or genre of the advertisement based on the metadata related to the object. In one embodiment, when user created object data is received for approval process in the interactive world review module 113 the specific space is reserved in the virtual world and at the same time a tag or label related to the object data is provided for an advertiser to place an advertisement in the specific space as long as the object data is in the approval process. Once the object data is approved it replaces the advertisement. If the object data is not allowable based on the criteria, at step 313, the interactive world platform 103 initiates transmission of a reason (e.g., an obscenity is in the tag, the location is restricted, the image resolution is too small, etc.) for the unallowable determination. At step 315, the interactive world platform 103 receives a modified request to upload object data, e.g., a tag, to the filtered virtual environment. Another determination of the allowable nature of the content is made at step 311.

If there is allowable content included in the object data, at step 317, the allowable object data is added to the filtered virtual environment. At step 319, the interactive world platform 103 receives a request for information about another (or subsequent) object. In one embodiment, the request is associated with the filtered virtual environment. In another embodiment, at step 321, the subsequent object is determined to be associated with the object data. The subsequent object can include object data that represents an image of a subsequent physical object within the physical environment. In this embodiment, the subsequent object data and the object data both represent the same physical object. This can be determined by processing and comparing location and orientation data associated with each object data. At step 323, the interactive world platform 103 can initiate transmission of information (e.g., a tag or label) associated with the object data to the requestor.

With the above approach, user-generated image recognition content can be filtered and edited to provide a filtered virtual environment. In this manner, the filtered virtual environment can be used to display information about an object to a user of a UE 101. Additionally, an editor can view the image in a virtual environment before the image is viewable by other users, allowing for a review of the virtual environment in a context similar to a user's context.

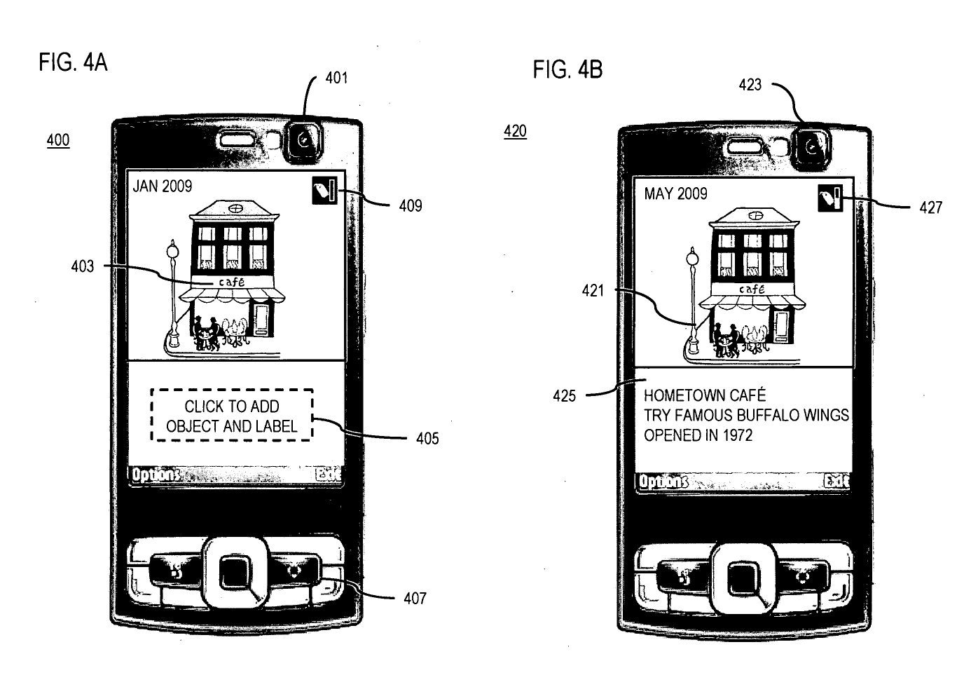

FIGS. 4A-4B are diagrams of user interfaces utilized in the processes of FIG. 3, according to various embodiments. User interface 400 can have a camera 401 that can capture an image (e.g., an image of a café 403). The user interface 400 displays a café that has not been tagged with information in a point and find application 107. In one embodiment, the user interface 400 has a touch-screen 405 or a button 407 input. A user can use the inputs to select the café 403 as an object to add to an image recognition database that can be stored as a virtual environment associated with restaurants. Further, the user can use the inputs 405 and/or 407 to type or otherwise select information, e.g. from a memory of the UE, to the tag or label related to the café 403 via the user interface 400. In one embodiment, the virtual environment is filtered. In an additional embodiment, the user can use the inputs to select a specific part of the image as an object, for example only the building of the café 403, the sign of the café, and/or the facade of the café, to add to an image recognition database that can be stored as the virtual environment associated with the restaurants. In yet another embodiment, the number of tags or labels in an area can be displayed using an icon 409 (e.g., a meter) that corresponds to the density or coverage of tags for image recognition in the area. In the user interface 400, the icon 409 displays that there are no tags or labels corresponding to any objects in the area.

User interface 420 displays a café 421. A camera 423 of the user interface 420 can point at the café 421. In one embodiment, a user can choose to find information about the café 421 using the virtual environment associated with restaurants. According to the virtual environment, the café 421 is associated with a tag 425 that has the name of the café 421, “Hometown Café.” In one embodiment, an icon 427 can be displayed corresponding to the number of tagged or labeled objects in a nearby area. The icon 427 shows that there are some tagged objects in the area that can be displayed. A tag has an advertisement of “try famous buffalo wings” associated with the café 421 and the opening date. Additional tags can be found in other virtual environments by scrolling and/or selecting a specific virtual environment in the user interface 420 by the touch-screen 405 or button 407 input.

In one embodiment, the virtual world and/or the objects on the virtual world can be selected based on the user context. For example, if the user is going for lunch the virtual world may be restaurant guide and/or only the tag and/or object are presented that has menu information available.

The above described processes advantageously ensure an efficient and effective approach to creating an augmented reality environment that improves user experience. In this manner, the review/approval mechanism avoids wasting system and network resources, such as in cases where users expend resources to access the virtual environment but fails to engage in the full experience (by “leaving”) because of the objectionable nature of the environment.

The processes described herein for filtering image recognition content may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

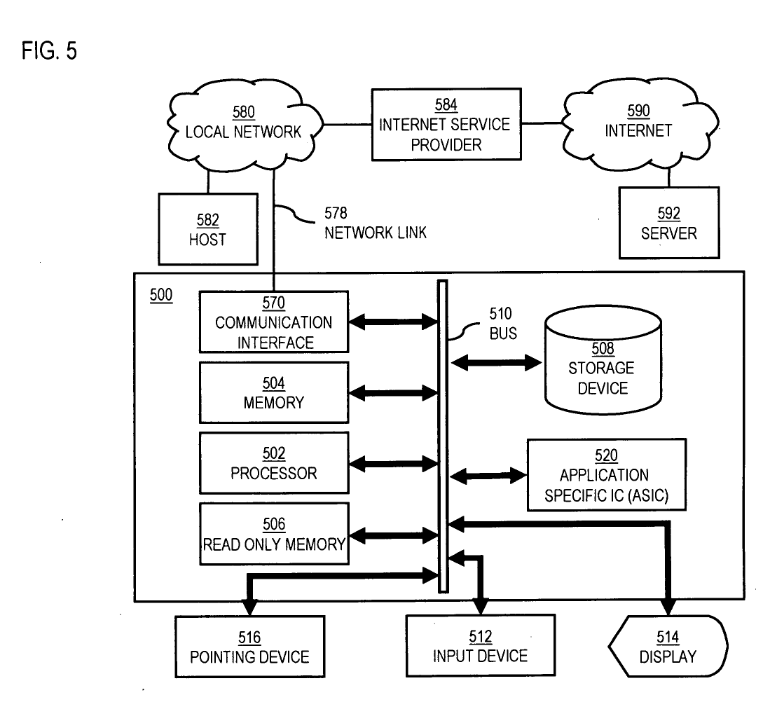

FIG. 5 illustrates a computer system 500 upon which an embodiment of the invention may be implemented. Computer system 500 is programmed (e.g., via computer program code or instructions) to filter image recognition content as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 510 includes one or more parallel conductors of information so that information is transferred quickly among devices coupled to the bus 510. One or more processors 502 for processing information are coupled with the bus 510.

A processor 502 performs a set of operations on information as specified by computer program code related to filtering media recognition content. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for filtering media recognition content. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for filtering media recognition content, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for providing image recognition services to the UE 101.

The term computer-readable medium is used herein to refer to any medium that participates in providing information to processor 502, including instructions for execution. Such a medium may take many forms, including, but not limited to, non-volatile media, volatile media and transmission media. Non-volatile media include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

FIG. 6 illustrates a chip set 600 upon which an embodiment of the invention may be implemented. Chip set 600 is programmed to filter image recognition content as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to filter media recognition content. The memory 605 also stores the data associated with or generated by the execution of the inventive steps.

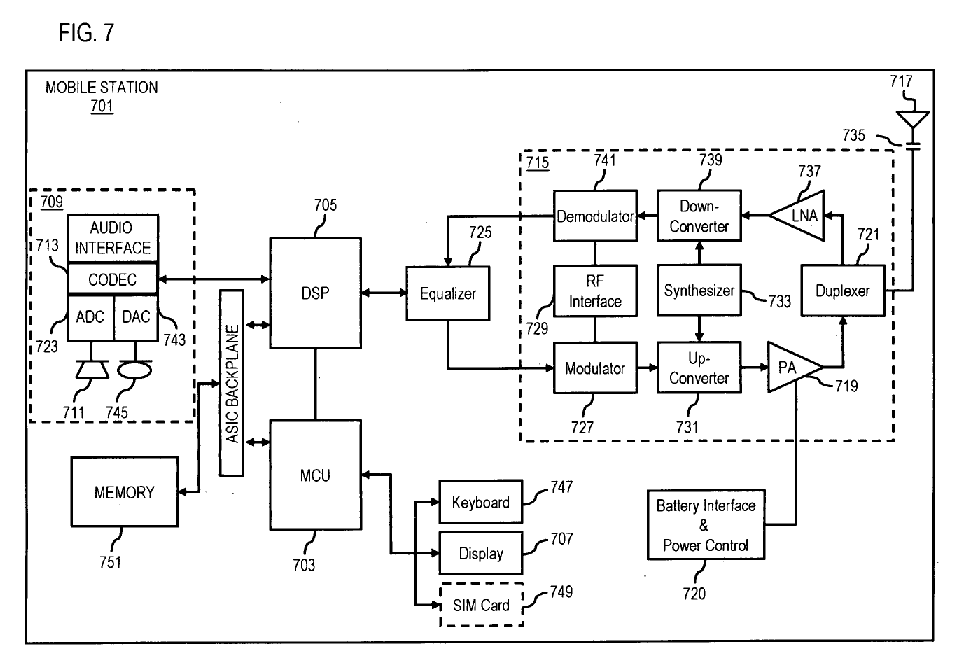

FIG. 7 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile station functions that offer automatic contact matching. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile station 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile station 701 to filter media recognition content. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the station. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile station 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile station 701 on a radio network. The card 749 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving object data and associated location information, wherein the object data represents an image of a physical object within a physical environment;
initiating storage of the received object data and the location information;
associating the received object data with a virtual environment corresponding to the physical environment; and
initiating approval of the received object data for inclusion in a filtered virtual environment.

2. A method of claim 1, wherein the received object data has been received and redirected from the filtered virtual environment.

3. A method of claim 1, wherein the object data comprises a tag, the method further comprising:
receiving an other object data and associated location information, wherein the object data represents an image of another physical object within the physical environment;
associating the other object data with the filtered virtual environment;
determining that the other object data is associated with the object data; and initiating transmission of the tag.

4. A method of claim 1, further comprising:
determining approval of the received object data based on criteria, wherein the criteria is determined by the filtered virtual environment.

5. A method of claim 4, wherein the criteria allows for an advertising data.

6. A method of claim 1, wherein the filtered virtual environment is one of a plurality of filtered virtual environments, and wherein the plurality of filtered virtual environments comprise private and public virtual environments.

7. A method of claim 6, further comprising receiving a request from a user equipment to associate the object data with the filtered virtual environment.

8. A method of claim 1, further comprising:
receiving an other object data and an other associated location information, wherein the other object data corresponds to an image of another physical object within the physical environment;
determining a number of objects associated with the object data corresponding to the other associated location information; and
initiating transmission of the number of associated objects.

9. An apparatus comprising:
at least one processor; and
at least one memory including computer program code,
the at least one memory and the computer program code configured to, with the at least one processor, cause the apparatus to perform at least the following,
receive object data and associated location information, wherein the object data represents an image of a physical object within a physical environment;
initiate storage of the received object data and the location information;
associate the received object data with a virtual environment corresponding to the physical environment; and
initiate approval of the received object data for inclusion in a filtered virtual environment.

10. An apparatus of claim 9, wherein the received object data has been received and redirected from the filtered virtual environment.

11. An apparatus of claim 9, wherein the object data comprises a tag, and wherein the apparatus is further caused to:
receive another object data and associated location information, wherein the object data represents an image of another physical object within the physical environment;
associate the other object data with the filtered virtual environment;
determine that the other object data is associated with the object data; and
initiate transmission of the tag.

12. An apparatus of claim 9, wherein the apparatus is further caused to:
determine approval of the received object data based on criteria, wherein the criteria is determined by the filtered virtual environment.

13. An apparatus of claim 12, wherein the criteria allows for an advertising data.

14. An apparatus of claim 9, wherein the filtered virtual environment is one of a plurality of filtered virtual environments, and wherein the plurality of filtered virtual environments comprise private and public virtual environments.

15. An apparatus of claim 14, wherein the apparatus is further caused to receive a request from a user equipment to associate the object data with the filtered virtual environment.

16. An apparatus of claim 9, wherein the apparatus is further caused to:
receive an other object data and an other associated location information, wherein the other object data corresponds to an image of another physical object within the physical environment;
determine a number of objects associated with the object data corresponding to the other associated location information; and
initiate transmission of the number of associated objects.

17. A computer-readable storage medium carrying one or more sequences of one or more instructions which, when executed by one or more processors, cause an apparatus to perform at least the following:
receive object data and associated location information, wherein the object data represents an image of a physical object within a physical environment;
initiate storage of the received object data and the location information;
associate the received object data with a virtual environment corresponding to the physical environment; and
initiate approval of the received object data for inclusion in a filtered virtual environment.

18. A computer-readable storage medium of claim 17, wherein the received object data has been received and redirected from the filtered virtual environment.

19. A computer-readable storage medium of claim 17, wherein the object data comprises a tag, and wherein the apparatus is further caused to:
receive another object data and associated location information, wherein the object data represents an image of another physical object within the physical environment;
associate the other object data with the filtered virtual environment;
determine that the other object data is associated with the object data; and
initiate transmission of the tag.

20. A computer-readable storage medium of claim 17, wherein the apparatus is further caused to:
determine approval of the received object data based on criteria, wherein the criteria is determined by the filtered virtual environment.
